(19) United States
(12) Patent Application Publication
(10) Pub. No.: US 2014/0007004 A1
(43) Pub. Date: Jan. 2, 2014

(54) METHOD AND APPARATUS FOR TASK CHAINING

(71) Applicants: Richard Michael Collin, East Sussex (GB); Graham Phillip Oldfield, London (GB)

(72) Inventors: Richard Michael Collin, East Sussex (GB); Graham Phillip Oldfield, London (GB)

(73) Assignee: NOKIA CORPORATION, Espoo (FI)

(21) Appl. No.: 13/538,787

(22) Filed: Jun. 29, 2012

(51) Int. Cl. G06F 3/0485

(52) U.S. Cl. CPC G06F 3/0485
USPC 715/784; 715/764

(57) ABSTRACT

Various methods are provided for enabling one or more tasks to be chained together, such that a user interacting with a user interface may scroll, back step or otherwise navigate through the one or more tasks in the task chain that may cross one or more software packages. One example method may include causing a first task of one or more tasks on a task chain to be displayed in a user interface. A method may further include determining, in response to a user interaction with the user interface, a second task of the one or more tasks on the task chain to be displayed in the user interface. A method may further include causing the second task to be in displayed in the user interface.

### TECHNOLOGICAL FIELD

Embodiments of the present invention relate generally to interface technologies and, more particularly, relate to a method, apparatus, and computer program product for task chaining in a task based operating environment.

### BACKGROUND

The modern computing era has brought about a tremendous expansion in computing power as well as increased affordability of computing devices. This expansion in computing power has led to a reduction in the size of computing devices and given rise to a new generation of mobile devices that are capable of performing functionality that only a few years ago required processing power provided only by the most advanced desktop computers. Consequently, mobile computing devices having a small form factor have become ubiquitous and are used by consumers of all socioeconomic backgrounds.

### BRIEF SUMMARY

Methods, apparatuses, and computer program products are provided herein for enabling one or more tasks to be chained together, such that a user interacting with a user interface may scroll, back step or otherwise navigate through the one or more tasks in the task chain that may cross one or more software packages. In some example embodiments, a task is added to a task chain at the time the task is launched. In further examples, a task launch may cause a task to be performed in another software package. Therefore, as tasks are added to the task chain, a user, via the user interface, may scroll backwards and forwards through the tasks and advantageously, for example, may scroll through tasks across software packages. The user may then select a particular task in the task chain, which enables the user to view that task in the particular software package that generated and/or otherwise provided the task.

In some example embodiments, a user may view a previous task in the task chain. While viewing a previous task (e.g. a parent task) in the task chain, the user may then select to perform a new task causing more than one task (e.g. the new task and the previous task) to be chained to the parent task, thus causing a branch or fork in the task chain (e.g. multitasking). In some example embodiments and in an instance of a branch or fork in the task chain, the most recently launched task may be chained to the parent task in the task chain. As a result the previous task and its progeny are removed from the task chain and form a new task chain, while enabling the current task chain to follow the new task and its progeny in a linear pattern.

In some example embodiments, a method is provided that comprises causing a first task of one or more tasks on a task chain to be displayed in a user interface. The method of this embodiment may also include determining, in response to a user interaction with the user interface, a second task of the one or more tasks on the task chain to be displayed in the user interface. The method of this embodiment may also include causing the second task to be in displayed in the user interface.

In further example embodiments, an apparatus is provided that includes at least one processor and at least one memory including computer program code with the at least one memory and the computer program code being configured, with the at least one processor, to cause the apparatus to at least cause a first task of one or more tasks on a task chain to be displayed in a user interface. The at least one memory and computer program code may also be configured to, with the at least one processor, cause the apparatus to determine, in response to a user interaction with the user interface, a second task of the one or more tasks on the task chain to be displayed in the user interface. The at least one memory and computer program code may also be configured to, with the at least one processor, cause the apparatus to cause the second task to be in displayed in the user interface.

In yet further example embodiments, a computer program product may be provided that includes at least one non-transitory computer-readable storage medium having computer-readable program instructions stored therein with the computer-readable program instructions including program instructions configured to cause a first task of one or more tasks on a task chain to be displayed in a user interface. The computer-readable program instructions may also include program instructions configured to determine, in response to a user interaction with the user interface, a second task of the one or more tasks on the task chain to be displayed in the user interface. The computer-readable program instructions may also include program instructions configured to cause the second task to be in displayed in the user interface.

In yet further example embodiments, an apparatus is provided that includes means for causing a first task of one or more tasks on a task chain to be displayed in a user interface. The apparatus of this embodiment may also include means for determining, in response to a user interaction with the user interface, a second task of the one or more tasks on the task chain to be displayed in the user interface. The apparatus of this embodiment may also include means for causing the second task to be in displayed in the user interface.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a block diagram of an apparatus that embodies a task based system using task chaining according to some example embodiments of the present invention;

FIG. 2 is a schematic block diagram of a mobile terminal according to some example embodiments of the present invention;

FIGS. 3a-c illustrate a variety of views of example task chains according to some example embodiments of the present invention;

FIGS. 4a-c illustrate a variety of representations of example task chains according to an example method in a task based operating system according to an example embodiment of the invention; and

FIG. 5 illustrates a flowchart according to an example method of task chaining according to an example embodiment of the invention.

### DETAILED DESCRIPTION

Example embodiments will now be described more fully hereinafter with reference to the accompanying drawings, in which some, but not all embodiments are shown. Indeed, the embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term “circuitry” refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in a server, a cellular network device, or other network device.

Example operating system environments are generally application centric. In an example application centric operating system environment, a user is able to launch an application by selecting an icon or some other representation of the application. In application centric operating system environments, a user is required to select a particular application that would enable a particular task to be performed. Once inside the application, the user may then take a variety of different actions to achieve a particular functionality. For example, an email application may be opened by selecting an icon that looks like a letter. Once opened, a user may read a message, send a message and/or the like. By way of further example, a user of an email application may have three different windows open, a first window that contains a draft email message to a first person, a second window containing a received message from a second person and a third email containing an inbox. Further still, a user may also have a social media application open with a number of windows. In an example application centric operating system environment, the user may switch between currently active applications. The user however always enters the application through a front end that generally starts with a splash screen followed by a home screen.

In some examples, an application centric operating system may have a process manager which may be further configured to display a list of applications and a list of windows that are tied to those one or more applications. In these cases and in an instance in which the system or user shuts down the application, then all windows related to that application may be removed and/or may disappear from view. Once removed from view, in order to access a particular feature or perform a task within the application, the user must again open the application and navigate through a splash screen and then through the application to a screen that may provide the particular feature or functionality.

Additional input mechanisms may be used in conjunction with an application centric operating system, for example an input system that is configured to receive a command “call” followed by an identifier, which is configured to activate a phone application and initiate a call to the provided identifier. Other short cuts such as call home or call voicemail may be used. However any shortcut, such as those identified above, are configured to open an identified application and/or are directly tied to a particular application.

In some examples of a task based system, application icons may not be presented to the user, may be hidden or otherwise obscured in the user interface thus preventing a user from accessing an application directly. Alternatively or additionally, in some example embodiments described herein, an application may not be directly accessible by the user. Instead and in some example embodiments, a task based system is disclosed herein that is configured to enable a user to provide a task to be accomplished to the user interface. In response, the systems and methods described herein may cause a software package to provide a view, take an action, and/or provide subtask, thereby enabling the user to operate in terms of tasks to be accomplished and not in terms of specific applications.

In some example embodiments, user interaction with a user interface is related to a task or a topic to be performed, an end state to be achieved, an intent to be carried out and/or like. In some examples, the task or topic received form the user is not application dependent, but instead is application independent. For example, an application independent task such as “play” may relate to subtasks such as “play music,” “play video,” “play a game,” and/or the like. As such, the user may be prompted with those subtasks. Even in an instance in which the task provided by the user via the user interface is “play music,” one or more software packages may be available that can provide music playing functionality. As such, a user may no longer be required to select a particular application and then navigate to a particular functionality of that application to perform a task, but instead may select a task without being concerned about choosing a particular software package that accomplishes the selected task.

In some example embodiments, the one or more software packages may be configured to expose one or more tasks that the software package is configured to perform. These exposed one or more tasks may then be selected by an example task chain management system based on the task that was input via the user interface. Upon receipt of a selection of the one or more tasks, the one or more software packages may be configured to launch, build or other provide a view on the user interface. Alternatively or additionally, the task may be configured to perform an action based on the task defined by the software package.

Alternatively or additionally, a task may also result in the display of a number of subtopics. For example, a task of “play” may result in a topic of “play” because there are a number of available subtasks in a task hierarchy, such as but not limited to “play music,” play video,” and/or “play a game.”

In some example embodiments, a task may be defined as a method to invoke functionality in the one or more software packages. As such, the tasks that are exposed by the one or more software packages function as an entry point into the one or more software packages. In other words, a software package may launch or build a view for the purpose of accomplishing the task. For example, and in response to a “play music” command, a music playing software package may launch, build or otherwise provide a view that displays available music to be played. Alternatively or additionally, the software package may be configured to perform an action such as playing a randomly selected song without the need to open the software package and navigate to the desired functionality.

By way of an additional example, a user may propose or input a task: “compose a status update.” In response, the system as described herein, may determine that this task is related to social media applications and, as such, may be configured to build, launch or otherwise provide a view in a first social media software package that enables the user to perform a status update. Again, the status update view is built or launched via the task chain management system without causing the user to navigate through the social media software package splash screen and through the other functionality of the software package in order to locate the status update functionality. After completing the status update, a new view from a second social media software package may be launched. Further and in some examples, the status update field in the second social media software package may be populated with the previously entered status update in the first social media software package. The second view may be launched in the second social media application because tasks may span multiple applications. In this case the task of performing a status update may be performed across multiple applications in order to accomplish the task

As the views are generated, a task chain is generated by the task chain management system allowing, for example, the user to switch between the view of the first social media software package that is configured to provide status updates and the view of the second social media software package that is configured to provide status updates without causing the user to open and close the individual software packages. Advantageously, the task chain, when displayed in the user interface, enables the user to navigate through all of the tasks in the chain without concern for the software package that generated the task.

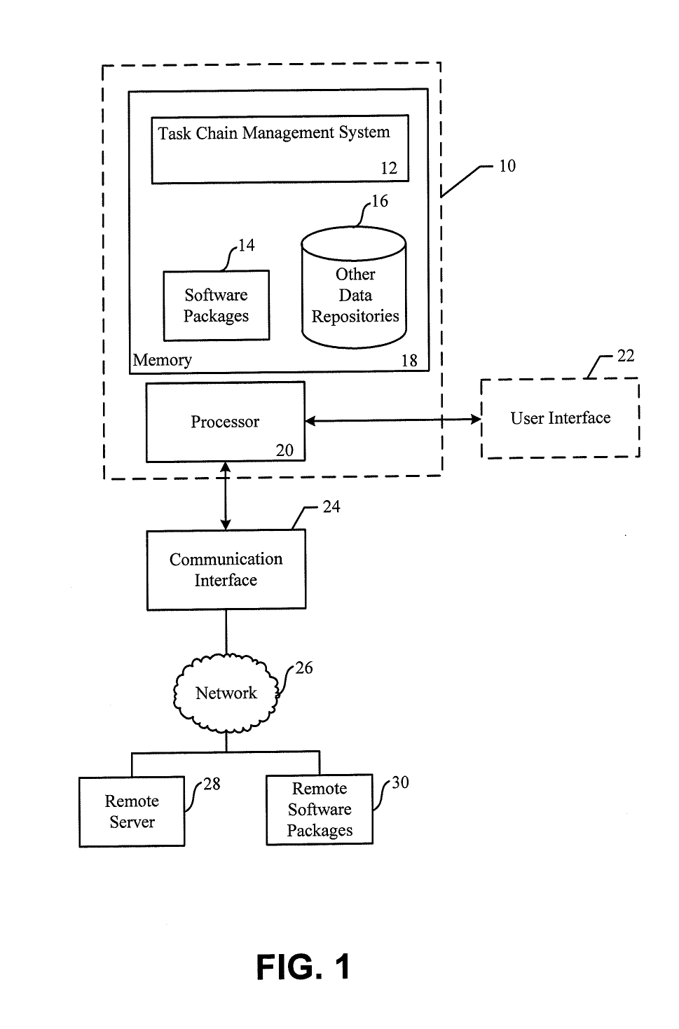

FIG. 1 illustrates a block diagram of a task chaining apparatus 10 configured to perform task chaining according to some example embodiments of the present invention. It will be appreciated that the task chaining apparatus 10 is provided as an example of an embodiment of the invention and should not be construed to narrow the scope or spirit of the invention in any way. In this regard, the scope of the disclosure encompasses many potential embodiments in addition to those illustrated and described herein. As such, while FIG. 1 illustrates one example of a configuration of an apparatus for facilitating task chaining other configurations may also be used to implement embodiments of the present invention.

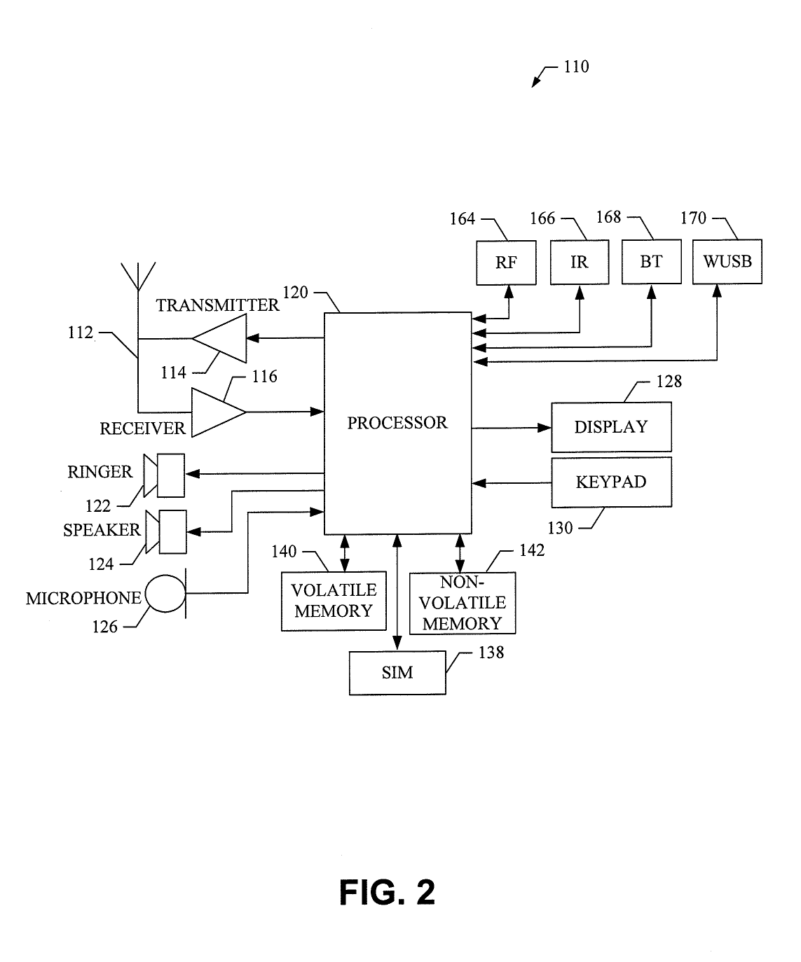

The task chaining apparatus 10 may be embodied as a desktop computer, laptop computer, mobile terminal, tablet, mobile computer, mobile phone, mobile communication device, tablet, one or more servers, one or more network nodes, game device, digital camera/camcorder, audio/video player, television device, radio receiver, digital video recorder, positioning device, any combination thereof, and/or the like. In an example embodiment, the task chaining apparatus 10 may be embodied as a mobile terminal, such as that illustrated in FIG. 2.

In this regard, FIG. 2 illustrates a block diagram of a mobile terminal 110 representative of one embodiment of a task chaining apparatus 10. It should be understood, however, that the mobile terminal 110 illustrated and hereinafter described is merely illustrative of one type of a task chaining apparatus 10 implementation that may benefit from embodiments of the present invention and, therefore, should not be taken to limit the scope of the present invention. While several embodiments of the user terminal (e.g., mobile terminal 110, user equipment or like) are illustrated and will be hereinafter described for purposes of example, other types of user terminals, such as mobile telephones, mobile computers, portable digital assistants (PDAs), pagers, laptop computers, desktop computers, gaming devices, televisions, and other types of electronic systems, may employ embodiments of the present invention.

As shown, the mobile terminal 110 may include an antenna 112 (or multiple antennas 112) in communication with a transmitter 114 and a receiver 116. The mobile terminal 110 may also include a processor 120 configured to provide signals to and receive signals from the transmitter and receiver, respectively. The processor 120 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 1 as a single processor, in some embodiments the processor 120 comprises a plurality of processors. These signals sent and received by the processor 120 may include signaling information in accordance with an air interface standard of an applicable cellular system, and/or any number of different wireline or wireless networking techniques, comprising but not limited to Wireless-Fidelity (Wi-Fi), wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal 110 may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (VAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 110 may be capable of operating according to WiFi or Worldwide Interoperability for Microwave Access (WiMAX) protocols.

It is understood that the processor 120 may comprise circuitry for implementing audio/video and logic functions of the mobile terminal 110. For example, the processor 120 may comprise a digital signal processor device, a microprocessor device, an analog-to-digital converter, a digital-to-analog converter, and/or the like. Control and signal processing functions of the mobile terminal 110 may be allocated between these devices according to their respective capabilities. Further, the processor may comprise functionality to operate one or more software packages, which may be stored in memory. For example, the processor 120 may be capable of operating a software package that provides connectivity, such as a view that functions as a web browser. The connectivity program may allow the mobile terminal 110 to transmit and receive web content, such as location-based content, according to a protocol, such as Wireless Application Protocol (WAP), hypertext transfer protocol (HTTP), and/or the like. The mobile terminal 110 may be capable of using a Transmission Control Protocol/Internet Protocol (TCP/IP) to transmit and receive web content across the internet or other networks.

The mobile terminal 110 may also comprise a user interface including, for example, an earphone or speaker 124, a ringer 122, a microphone 126, a display 128, a user input interface, and/or the like, which may be operationally coupled to the processor 120. In this regard, the processor 120 may comprise user interface circuitry configured to control at least some functions of one or more elements of the user interface, such as, for example, the speaker 124, the ringer 122, the microphone 126, the display 128, and/or the like. The processor 120 and/or user interface circuitry comprising the processor 120 may be configured to control one or more functions of one or more elements of the user interface through computer program instructions (e.g., software and/or firmware) stored on a memory accessible to the processor 120 (e.g., volatile memory 140, non-volatile memory 142, and/or the like). The mobile terminal 110 may comprise sensors, such as a GPS 136, which may determine location information for the user. Although not shown, the mobile terminal may comprise a battery for powering various circuits related to the mobile terminal, for example, a circuit to provide mechanical vibration as a detectable output. The user input interface may comprise devices allowing the mobile terminal to receive data, such as a keypad 130, a touch display (not shown), a joystick (not shown), and/or other input device. In embodiments including a keypad, the keypad may comprise numeric (0-9) and related keys (#, *), and/or other keys for operating the mobile terminal.

The mobile terminal 110 may comprise memory, such as a smart cart, subscriber identity module or subscriber identification module (SIM), a removable user identity module (R-UIM), and/or the like, which may store information elements related to a mobile subscriber. In addition to the SIM, the mobile terminal may comprise other removable and/or fixed memory. The mobile terminal 110 may include other non-transitory memory, such as volatile memory 140 and/or non-volatile memory 142. For example, volatile memory 140 may include Random Access Memory (RAM) including dynamic and/or static RAM, on-chip or off-chip cache memory, and/or the like. Non-volatile memory 142, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 140 non-volatile memory 142 may include a cache area for temporary storage of data. The memories may store one or more software programs, instructions, pieces of information, data, and/or the like which may be used by the mobile terminal for performing functions of the mobile terminal. For example, the memories may comprise an identifier, for example an international mobile equipment identification (IMEI) code, capable of uniquely identifying the mobile terminal 110.

Returning to FIG. 1, in an example embodiment, a task chaining apparatus 10 includes various means for performing the various functions herein described. These means may comprise one or more of a task chain management system 12, at least one memory 18, at least one processor 20, a user interface 22, and a communication interface 24. The means of the task chaining apparatus 10 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 18) that is executable by a suitably configured processing device (e.g., the processor 20), or some combination thereof.

Note that one or more general purpose or special purpose computing systems/devices may be used to implement the task chaining apparatus 10. In addition, the task chaining apparatus 10 may comprise one or more distinct computing systems/devices and may span distributed locations. Furthermore, each block shown may represent one or more such blocks as appropriate to a specific embodiment or may be combined with other blocks. For example, in some embodiments, the task chaining apparatus 10 may contain a task chain management system 12. In other example embodiments a task chain management system 12 may be configured to operate remotely. In some example embodiments, a pre-computation module may be configured to perform the computational load and thus may be on a remote device. Also, the task chaining apparatus 10 and/or the task chain management system 12 may be implemented in software, hardware, firmware, or in some combination to achieve the capabilities described herein.

In an example embodiment, components/modules of the task chaining apparatus 10 are implemented using standard programming techniques. For example, the task chaining apparatus 10 may be implemented as a “native” executable running on the processor 20, along with one or more static or dynamic libraries. In other embodiments, the task chaining apparatus 10 may be implemented as instructions processed by a virtual machine that executes as another program or software package. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., Structured Query Language (SQL), Prolog, and the like).

The embodiments described above may also use either well-known or proprietary synchronous or asynchronous client-server computing techniques. Also, the various components may be implemented using more monolithic programming techniques, for example, as an executable running on a single processor computer system, or alternatively decomposed using a variety of structuring techniques known in the art, including but not limited to, multiprogramming, multithreading, client-server, or peer-to-peer, running on one or more computer systems each having one or more processors. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the task chaining apparatus 10 can be made available by standard mechanisms such as through C, C++, C#, and Java application programming interfaces; libraries for accessing files, databases, or other data repositories; through languages such as Extensible Markup Language (XML); or through Web servers, File Transfer Protocol (FTP) servers, or other types of servers providing access to stored data.

Different configurations and locations of programs and data are contemplated for use with techniques described herein. A variety of distributed computing techniques are appropriate for implementing the components of the illustrated embodiments in a distributed manner including but not limited to Transmission Control Protocol (TCP)/Internet Protocol (IP) sockets, remote procedure call (RPC), Remote Method Invocation (RMI), HTTP, Web Services (XML-remote procedure call (RPC), JAX-RPC, Simple Object Access Protocol (SOAP), and the like). Other variations are possible. Also, other functionality could be provided by each component/module, or existing functionality could be distributed amongst the components/modules in different ways, yet still achieve the functions described herein.

The processor 20 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC or FPGA, or some combination thereof. Accordingly, although illustrated in FIG. 1 as a single processor, in some embodiments the processor 20 comprises a plurality of processors. The plurality of processors may be in operative communication with each other and may be collectively configured to perform one or more functionalities of the task chaining apparatus 10 as described herein. The plurality of processors may be embodied on a single computing device or distributed across a plurality of computing devices collectively configured to function as the task chaining apparatus 10. In embodiments wherein the task chaining apparatus 10 is embodied as a mobile terminal 110, the processor 20 may be embodied as or comprise the processor 120. In an example embodiment, the processor 20 is configured to execute instructions stored in the memory 18 or otherwise accessible to the processor 20. These instructions, when executed by the processor 20, may cause the task chaining apparatus 10 to perform one or more of the functionalities of the task chaining apparatus 10 as described herein. As such, whether configured by hardware or software methods, or by a combination thereof, the processor 20 may comprise an entity capable of performing operations according to embodiments of the present invention while configured accordingly. Thus, for example, when the processor 20 is embodied as an ASIC, FPGA or the like, the processor 20 may comprise specifically configured hardware for conducting one or more operations described herein. Alternatively, as another example, when the processor 20 is embodied as an executor of instructions, such as may be stored in the memory 18, the instructions may specifically configure the processor 20 to perform one or more algorithms and operations described herein.

The memory 18 may comprise, for example, transitory and/or non-transitory memory, such as volatile memory, non-volatile memory, or some combination thereof. Although illustrated in FIG. 1 as a single memory, the memory 18 may comprise a plurality of memories. The plurality of memories may be embodied on a single computing device or may be distributed across a plurality of computing devices collectively configured to function as the task chaining apparatus 10. In various example embodiments, the memory 18 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the task chaining apparatus 10 is embodied as a mobile terminal 110, the memory 18 may comprise the volatile memory 140 and/or the non-volatile memory 142. The memory 18 may be configured to store information, data, applications, other data repositories, such as data repository 16, instructions, or the like for enabling the task chaining apparatus 10 to carry out various functions in accordance with various example embodiments.

The communication interface 24 may be embodied as any device or means embodied in circuitry, hardware, a computer program product comprising computer readable program instructions stored on a computer readable medium (e.g., the memory 18) and executed by a processing device (e.g., the processor 20), or a combination thereof that is configured to receive and/or transmit data to/from another computing device. For example, the communication interface 24 may be configured to receive application data over a network. The task chaining apparatus 10 may interact via the network 26 via a communication interface 24 with one or more remote servers 28 and/or with remote software packages 30. The network 26 may be any combination of media (e.g., twisted pair, coaxial, fiber optic, radio frequency), hardware (e.g., routers, switches, repeaters, transceivers), and protocols (e.g., TCP/IP, LTE, UDP, Ethernet, Wi-Fi, WiMAX) that facilitate communication between remotely situated humans and/or devices. In this regard, the communications interface 24 may be capable of operating with one or more air interface standards, communication protocols, modulation types, access types, and/or the like.

The user interface 22 may be in communication with the processor 20 to receive an indication of a user input, such as a task to be performed, at the user interface and/or to provide an audible, visual, mechanical or other output to the user. As such, the user interface may include, for example, a keyboard, a mouse, a trackball, a display, a touch screen, a microphone, a speaker, multimodal interface and/or other input/output mechanisms.

While the task chaining apparatus 10 may be employed, for example, by a mobile terminal and/or a stand-alone system (e.g. remote server), it should be noted that the components, devices or elements described below may not be mandatory and thus some may be omitted in certain embodiments. Additionally, some embodiments may include further or different components, devices or elements beyond those shown and described herein.

An example task chaining apparatus 10 is configured, in some example embodiments, to enable a user to interact in a task based environment with one or more software packages 14 via a user interface 22. The user interface 22 is configured to receive the one or more task requests from a user, an application, a user interacting with an application, a sensor, or the like. The task requests may take the form of a selection, a text input, a voice command and/or other multimodal input. The user interface 22 is then configured to pass the one or more task requests to the task chain management system 12.

The task chain management system 12 may then query or otherwise determine from the one or more software packages 14 whether a task is available that matches and/or is similar to the received task. A task matches or is similar to another task in an instance which the task received via the user interface 22 has a similar intent, end state, purpose or the like to the one or more tasks exposed by the one or more software packages 14. Once a task is determined to match an exposed task, the exposed task may then result in a view from the one or more software packages 14 to be presented via the user interface 22 (e.g. a screen that meets the intent of the task), in an action being performed via the one or more software packages (e.g. phone call is initiated), and/or in one or more subtasks for the task being displayed in the user interface.

In some example embodiments, the task chain management system 12 may be configured to chain, link and/or otherwise connect one or more tasks in a task chain. A task is added to the task chain as each task is performed and/or launched. For example, a first task such as a contacts search may lead to a second task in an instance in which a user selects a phone number to call. The first task (e.g. contacts search) and the second task (e.g. phone call) are chained together to form a task chain.

The task chain may comprise: tasks related to a topic, a quantity of tasks, such as the last twenty tasks performed, tasks performed over a particular time period or the like. Further, the task chain management system 12 may maintain a single task chain or may maintain a plurality of task chains.

In some example embodiments, the task chain may be built such that a view or an action is captured for each task. For example, in an instance in which a previous task is viewed, the previous is displayed and contains the same data as was displayed when the user last activated the previous view. In other example embodiments, the task chain management system 12 may refresh the previous view, such that a fresh default view is presented to the user. Additionally, each of the views in the task chain may be from the same software package 14 or may span a plurality of different software packages 14.

The task chain management system 12 may further support multitasking. In some example embodiments, a branch or fork may occur in a task chain, for example in an instance in which a first task is launched from a parent task and then a second task is launched from the same parent task. The fork or branch may occur in an instance in which a user follows a first task path and then, using the systems and methods described herein, returns to the parent task and selects a second task. For example, a user may search for a restaurant in a search enabled software package. Then once the restaurant is found, the user may call the restaurant to see if there is availability (e.g. first task). If there is availability, the user may then back step through the task chain to the parent task in the search engine, and then may select the address to restaurant such that a navigation software package is activated this is configured to provide directions to the restaurant (e.g. second task).

In the case of the fork or branch, the task chain management system 12 may then be configured to determine which of the example first task or the second task to leave connected to the task chain containing the parent task. In some example embodiments, the older or prior task (e.g. the first task) may be removed from the task chain and the newer or more recent task (e.g. the second task) may remain connected to the task chain. In an instance in which a task is removed from a task chain (e.g. chain is broken), the removed task may form a separate task chain. Alternatively or additionally a fork or branch may result in the fork or branch being displayed via the user interface for a user decision. In some cases, the branch or fork may be preserved in the task chain.

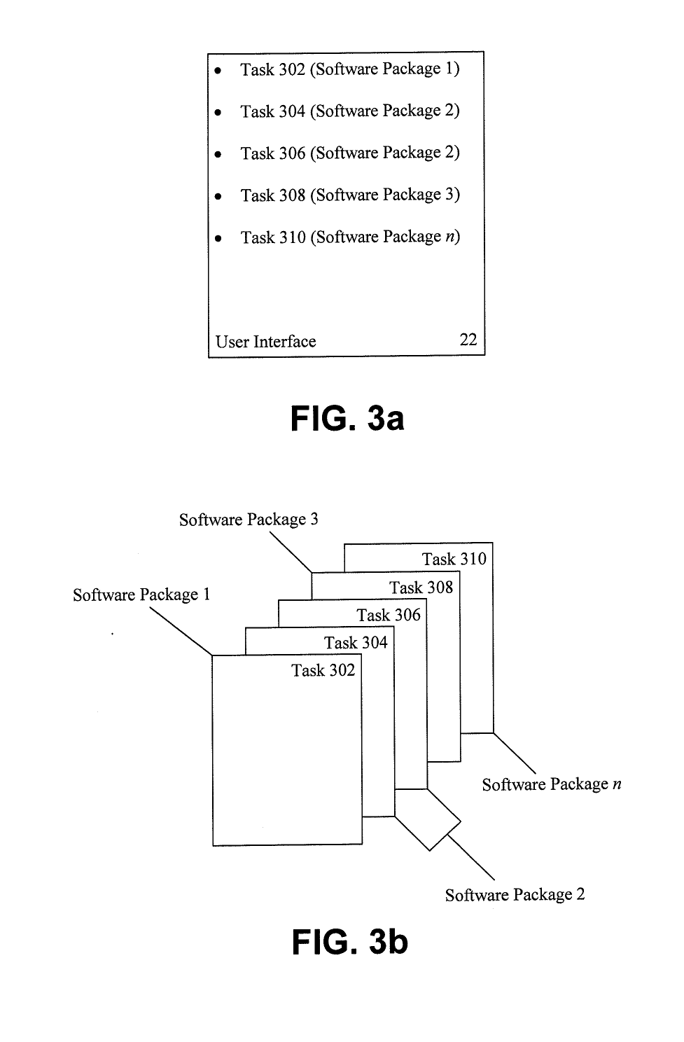

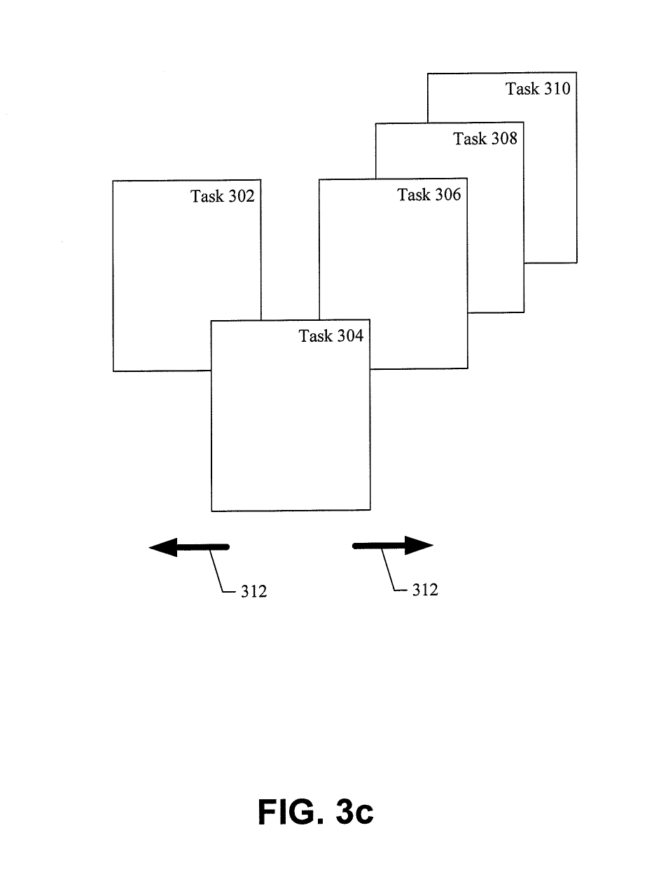

The task chain management system 12 may be configured to cause the task chain to be displayed in the user interface 22. The task chain may be displayed in the user interface 22 through a variety of different display means (see for example FIGS. 3a-c and 4a-c), however each display may be configured to allow a user to back step, navigate, scroll or otherwise view each of the tasks in the task chain. In some cases, a portion of the task chain or a portion of a task in the task chain may be made visible in the user interface 22, however in either case the view provided may be configured to be suggestive of the tasks in the task chain to the user. The user interface 22 may further enable the user to select a task from the task chain and upon selection, the task chain management system 12 may cause that task be displayed in the user interface 22.

In example embodiments, a user may manipulate the task chain via the user interface 22. The task chain may be manipulated such that tasks may be removed, added, modified and/or reorganized. In some cases, an existing task or a new task may be designated to exist in a new task chain. In other instances multiple task chains may be combined.

Alternatively or additionally, in some example embodiments, an interaction with a task in the task chain may result in one or more other tasks in the task chain being manipulated by the task chain management system 12. For example, an update in a first task may automatically result in an update in a second task in the task chain or vice versa. Such that, in an instance in which a user makes an update in a first task, the same update will be provided to an earlier or later task in the task chain.

FIG. 3a illustrates an example task listing in a user interface 22 in accordance with some example embodiments of the present invention. As was described with respect to FIG. 1, a user interface 22 may comprise a series of available tasks, such as tasks 302-310. Each of the tasks 302-310 may be provided by different software packages. Each of the displayed tasks may be selected by a user. On selection, a task may result in a view generated by a software package, an action taken by a software package and/or a topic may be generated by the task chain management system. In an instance in which a task is selected otherwise launched, the task may be added to a task chain, such as by task chain management system 12.

FIG. 3b illustrates an example task chain in accordance with example embodiments of the present invention. In an instance in which the tasks 302-310 were selected and/or otherwise launched in numerical order, an example task chain, such as the task chain shown with reference to FIG. 3b, may be formed. As is shown in FIG. 3b, the task chain may encompass one or more different software packages. As such, a user, via the user interface 22, may navigate between software packages on a task by task basis.

FIG. 3c illustrates an example user interface in accordance with some example embodiments of the present invention. Assuming an example task chain having tasks 302-310 that were added to the task chain in numerical order, a user interface may be configured to enable a user to back step, navigate or otherwise move backwards through the task chain such as by selecting arrow 312, using a swipe motion, a gesture motion, a command, a voice input and/or any other input. Likewise, an example user interface may further enable a user to navigate forward, in some example embodiments, by selecting arrow 314, using a swipe motion, a gesture motion, a command, a voice input and/or any other input. In some examples, when a task is selected, highlighted or is otherwise prominently displayed, a further view of the task me be shown in the user interface 22 that includes a portion, snapshot, or other display of the view or action provided by that task. Portions of other tasks and the views that they embody may also be displayed in the user interface 22.

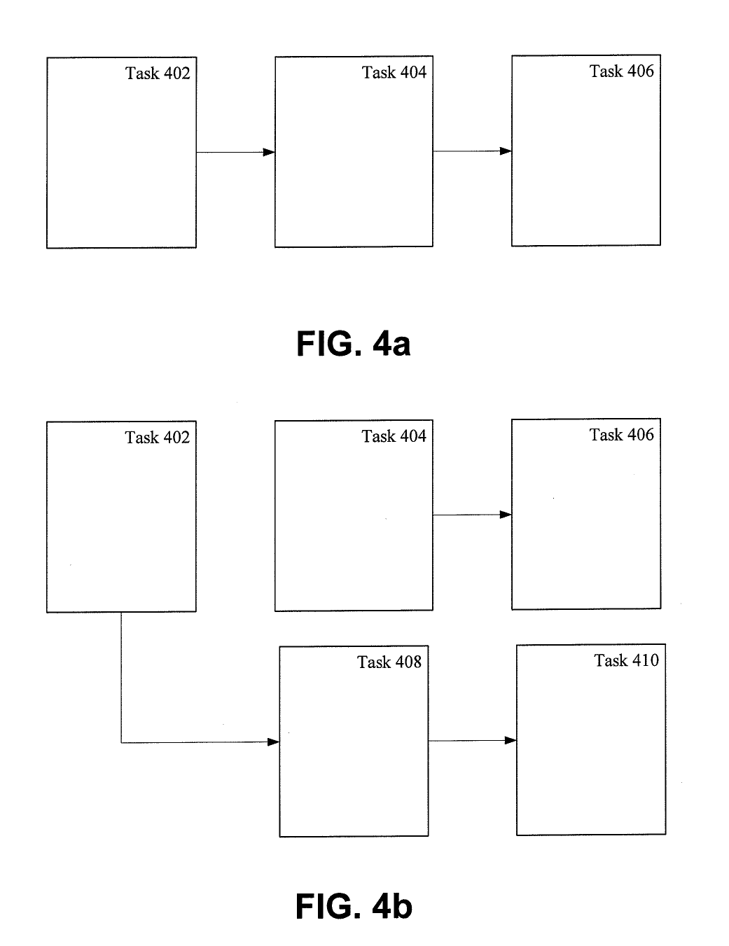

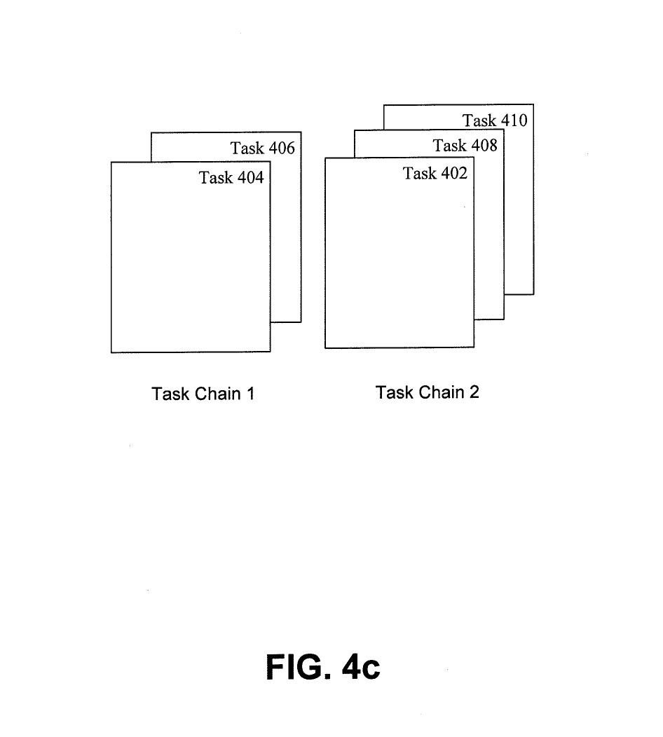

FIG. 4a illustrates a conceptual view of an example task chain according some examples of the present invention. As is shown in FIG. 4a, a first task 402 may launch or otherwise cause a second task 404, which then may launch or otherwise cause a third task 406. In such cases a task chain is formed. However, and as shown in FIG. 4b, a branch or fork may occur in the task chain. As is shown in FIG. 4a, the second task 404 was launched or otherwise caused by task 402. In FIG. 4b, an additional task, such as a fourth task 408, may be launched or otherwise caused by task 402, such as in an instance in which a user back steps to task 402 from task 406. As such, the latest task, task 408, is added to the task chain and task 404 is separated from the task chain. In such cases task 404 may be the start of a new task chain as is shown with reference to FIG. 4c.

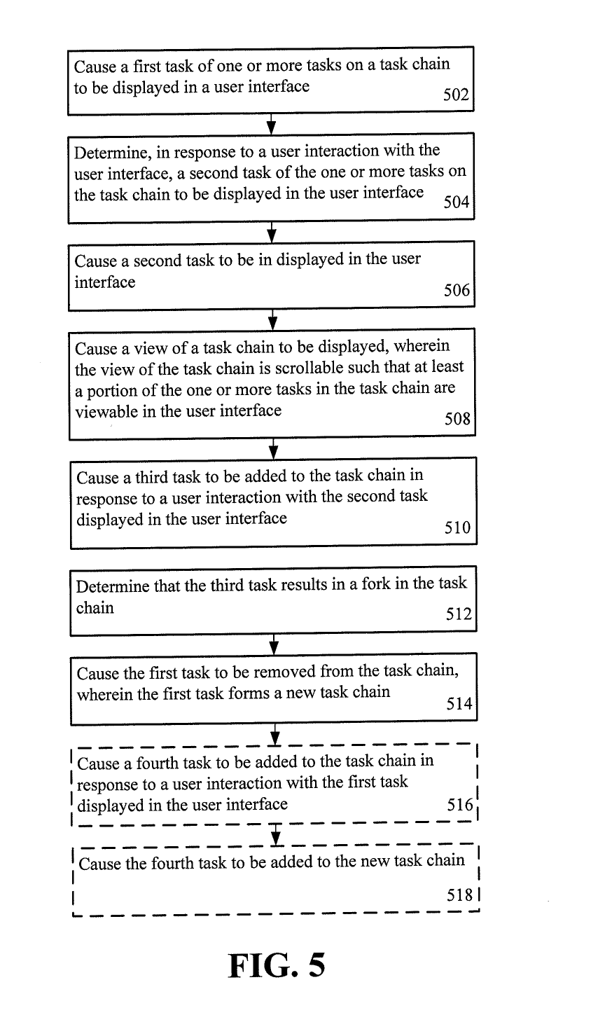

FIG. 5 illustrate an example flowchart of the operations performed by a task chaining apparatus 10 and/or the mobile terminal 110, in accordance with one embodiment of the present invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory 18, volatile memory 140 and/or non-volatile memory 142 of an apparatus employing an embodiment of the present invention and executed by a processor 20 or processor 120 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIG. 5, when executed, convert a computer or processing circuitry into a particular machine configured to perform an example embodiment of the present invention. Accordingly, the operations of FIG. 5 define an algorithm for configuring a computer or processor, to perform an example embodiment. In some cases, a general purpose computer may be provided with an instance of the processor which performs the algorithm of FIG. 5 to transform the general purpose computer into a particular machine configured to perform an example embodiment.

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations herein may be modified, marked option or further amplified as described below. Moreover, in some embodiments additional optional operations may also be included (some examples of which are shown in dashed lines in FIG. 5). It should be appreciated that each of the modifications, optional additions or amplifications below may be included with the operations above either alone or in combination with any others among the features described herein.

FIG. 5 illustrates a flowchart according to an example method of task chaining according to an example embodiment of the invention. As shown in operation 502, an apparatus embodied, for example, by a task chaining apparatus 10 and/or a mobile terminal 110, may include means, such as the task chain management system 12, the processor 20, the user interface 22 or the like, for causing a first task of one or more tasks on a task chain to be displayed in a user interface. As shown in operation 504, an apparatus embodied, for example, by a task chaining apparatus 10 and/or a mobile terminal 110, may include means, such as the task chain management system 12, the processor 20, the user interface 22 or the like, for determining, in response to a user interaction with the user interface, a second task of the one or more tasks on the task chain to be displayed in the user interface. As shown in operation 506, an apparatus embodied, for example, by a task chaining apparatus 10 and/or a mobile terminal 110, may include means, such as the task chain management system 12, the processor 20, the user interface 22 or the like, for causing a second task to be in displayed in the user interface. In some example embodiments, the first task is associated with a first software package and the second task is associated with a second software package. In other example embodiments, the second task was added to the task chain before the first task was added to the task chain. Alternatively or additionally, the first task was added to the task chain before the second task was added to the task chain.

As shown in operation 508, an apparatus embodied, for example, by a task chaining apparatus 10 and/or a mobile terminal 110, may include means, such as the task chain management system 12, the processor 20, the user interface 22 or the like, for causing a view of a task chain to be displayed. In some example embodiments, the view of the task chain is scrollable such that at least a portion of the one or more tasks in the task chain are viewable in the user interface. In some example embodiments, the view of the task chain that is scrollable is configured such that each task in the task chain is viewable by a user in the user interface.

As shown in operation 510, an apparatus embodied, for example, by a task chaining apparatus 10 and/or a mobile terminal 110, may include means, such as the task chain management system 12, the processor 20, the user interface 22 or the like, for causing a third task to be added to the task chain in response to a user interaction with the second task displayed in the user interface. In some example embodiments, the third task is associated with at least one of the first software package, the second software package or a third software package.

As shown in operation 512, an apparatus embodied, for example, by a task chaining apparatus 10 and/or a mobile terminal 110, may include means, such as the task chain management system 12, the processor 20, or the like, for determining that the third task results in a fork in the task chain. As shown in operation 514, an apparatus embodied, for example, by a task chaining apparatus 10 and/or a mobile terminal 110, may include means, such as the task chain management system 12, the processor 20, or the like, for causing the first task to be removed from the task chain. In some example embodiments, the first task forms a new task chain.

As shown in operation 516, an apparatus embodied, for example, by a task chaining apparatus 10 and/or a mobile terminal 110, may include means, such as the task chain management system 12, the processor 20, the user interface 22 or the like, for causing a fourth task to be added to the task chain in response to a user interaction with the first task displayed in the user interface. As shown in operation 518, an apparatus embodied, for example, by a task chaining apparatus 10 and/or a mobile terminal 110, may include means, such as the task chain management system 12, the processor 20, or the like, for causing the fourth task to be added to the new task chain. In some example embodiments, the new task chain is configured such that the first task and fourth task are viewable by the user in the user interface. In some example embodiments another task may be determined to be unrelated to a current task chain and as such a new task chain may be created, such as by the task chain management system 12.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
causing a first task of one or more tasks on a task chain to be displayed in a user interface;
determining, in response to a user interaction with the user interface, a second task of the one or more tasks on the task chain to be displayed in the user interface; and
causing the second task to be in displayed in the user interface.

2. A method according to claim 1, further comprising:
causing a view of the task chain to be displayed, wherein the view of the task chain is scrollable such that at least a portion of the one or more tasks in the task chain are viewable in the user interface.

3. A method according to claim 2, wherein the view of the task chain that is scrollable is configured such that each task in the task chain is viewable by a user in the user interface.

4. A method according to claim 2, wherein the first task is associated with a first software package and the second task is associated with a second software package.

5. A method according to claim 2, wherein the second task was added to the task chain before the first task was added to the task chain.

6. A method according to claim 2, wherein the first task was added to the task chain before the second task was added to the task chain.

7. A method according to claim 6, further comprising:
causing a third task to be added to the task chain in response to a user interaction with the second task displayed in the user interface, wherein the third task is associated with at least one of a first software package, a second software package or a third software package.

8. A method according to claim 7, further comprising:
determining that the third task results in a fork in the task chain; and
causing the first task to be removed from the task chain, wherein the first task forms a new task chain.

9. A method according to claim 8, further comprising:
causing a fourth task to be added to the task chain in response to a user interaction with the first task displayed in the user interface;
causing the fourth task to be added to the new task chain, wherein the new task chain is configured such that the first task and the fourth task are viewable by a user in the user interface.

10. A method according to claim 2, further comprising:
receiving an indication of a third task in response to a user interaction with the user interface;
determining that the third task is unrelated to the one or more tasks in the task chain; and
causing a new task chain with the third task to be created.

11. An apparatus comprising:
at least one processor; and
at least one memory including computer program code, the at least one memory and the computer program code configured to, with the at least one processor, cause the apparatus to at least:
cause a first task of one or more tasks on a task chain to be displayed in a user interface;
determine, in response to a user interaction with the user interface, a second task of the one or more tasks on the task chain to be displayed in the user interface; and
cause the second task to be in displayed in the user interface.

12. An apparatus according to claim 11, wherein the at least one memory including the computer program code is further configured to, with the at least one processor, cause the apparatus to:
cause a view of the task chain to be displayed, wherein the view of the task chain is scrollable such that at least a portion of the one or more tasks in the task chain are viewable in the user interface.

13. An apparatus according to claim 12, wherein the view of the task chain that is scrollable is configured such that each task in the task chain is viewable by a user in the user interface.

14. An apparatus according to claim 12, wherein the first task is associated with a first software package and the second task is associated with a second software package.

15. An apparatus according to claim 12, wherein the second task was added to the task chain before the first task was added to the task chain.

16. An apparatus according to claim 12, wherein the first task was added to the task chain before the second task was added to the task chain.

17. An apparatus according to claim 16, wherein the at least one memory including the computer program code is further configured to, with the at least one processor, cause the apparatus to:
cause a third task to be added to the task chain in response to a user interaction with the second task displayed in the user interface, wherein the third task is associated with at least one of a first software package, a second software package or a third software package.

18. An apparatus according to claim 17, wherein the at least one memory including the computer program code is further configured to, with the at least one processor, cause the apparatus to:
determine that the third task results in a fork in the task chain; and
cause the first task to be removed from the task chain, wherein the first task forms a new task chain.

19. An apparatus according to claim 18, wherein the at least one memory including the computer program code is further configured to, with the at least one processor, cause the apparatus to:
cause a fourth task to be added to the task chain in response to a user interaction with the first task displayed in the user interface;
cause the fourth task to be added to the new task chain, wherein the new task chain is configured such that the first task and the fourth task are viewable by a user in the user interface.

20. A computer program product comprising:
at least one computer readable non-transitory memory medium having program code stored thereon, the program code which when executed by an apparatus cause the apparatus at least to:
cause a first task of one or more tasks on a task chain to be displayed in a user interface;
cause a view of the task chain to be displayed, wherein the view of the task chain is scrollable such that at least a portion of the one or more tasks in the task chain are viewable in the user interface;
determine, in response to a user interaction with the user interface, a second task of the one or more tasks on the task chain to be displayed in the user interface; and
cause the second task to be in displayed in the user interface.
